(19) United States
(12) Patent Application Publication
(10) Pub. No.: US 2005/0073410 A1
(43) Pub. Date: Apr. 7, 2005

(54) TWO-PIECE ADJUSTABLE AUTO-SEARCH ALARM DEVICE

(76) Inventors: Benson Chiang, Chung-Ho City (TW); Wen Liang Hu, Chung-Ho City (TW)

Correspondence Address: RABIN & BERDO, P.C., Suite 500, 1101 14th Street, N.W., Washington, DC, 20005, US

(21) Appl. No.: 10/667,664

(22) Filed: Sep. 23, 2003

(51) Int. Cl. G08B 1/08

(52) U.S. Cl. 340/539.21

(57) ABSTRACT

A two-piece adjustable auto-search alarm device enables two-way transmission of alarm signals between a master and more than one secondary controller thereof, and includes a signal transmitter, a signal receiver, a frequency regulator, and an operation unit provided in the master controller, and a signal transmitter and a signal receiver provided in each secondary controller. The master controller is unable to receive a signal from the secondary signal transmitter when the secondary controller is located beyond a signal transmitting range set with the frequency regulator or fails to feed back a signal to the master controller due to losing its power supply, and LED lamps provided on the master and secondary controllers would light at the same time to provide the function of supervising a distance between the master and the secondary controller.

### FIELD OF THE INVENTION

The present invention relates to a two-piece adjustable auto-search alarm device for effectively supervising a distance between an article and a user, and more particularly to a one-to-many two-way alarm device of which a master controller may be regulated to a specific frequency to limit a distance within which the master controller may receive signal transmitted from a corresponding secondary controller. Buzzers provided on the two controllers emit sounds at the same time when the secondary controller fails to transmit a signal to the master controller due to being moved out of the specified distance or losing its power supply.

### BACKGROUND OF THE INVENTION

FIG. 1 shows a conventional alarm device A1, which is usually a semi-mechanical device. As shown, when a pull ring A2 on the alarm device A1 is pulled outward by a distance exceeded a preset length, the pull ring A2 is separated from the alarm device A1 and causes the latter to emit sounds.

There are also other types of alarm devices available in the markets, such as an automotive alarm device. The automotive alarm device gets working power from the battery of a car on which the alarm device is mounted. When the car is started without authorization, a voltage change thereof would cause the alarm device to buzz. However, this type of alarm device does not enable a car owner or a parking lot manager to immediately know the status of the car.

Therefore, the following problems are often found in the conventional alarm devices:

1. The conventional semi-mechanical alarm device could not overcome the problem of a fixed wiring length.

2. The conventional semi-mechanical alarm device could not be freely set to a desired working range.

3. The conventional semi-mechanical alarm device has limited applications.

4. The conventional automotive alarm device does not enable a car owner to be notified of the current status of the car.

5. The conventional automotive alarm devices could not be simultaneously supervised and controlled from a control center.

### SUMMARY OF THE INVENTION

It is therefore a primary object of the present invention to provide a two-piece adjustable auto-search alarm device that is an electronic frequency-changeable alarm device without the problem of fixed wiring length.

Another object of the present invention is to provide a two-piece adjustable auto-search alarm device having a master frequency regulator for regulating the alarm device to different working ranges as desired.

A further object of the present invention is to provide a two-piece adjustable auto-search alarm device that has wide applications, such as being connected to other electronic appliances, including a mobile phone or a battery thereof, and motors included in a water-pumping system for buildings or fish farms.

A still further object of the present invention is to provide a two-piece adjustable auto-search alarm device that includes a master controller carried by a user and a secondary controller connected to a power supply on an article, such as a car. When the car is moved into a location beyond a distance preset for the alarm device, or when the car has unstable power supply, LED lamps and buzzers provided on the master and the secondary controller light and buzz to warn the car owner.

A still further object of the present invention is to provide a two-piece adjustable auto-search alarm device that includes a master controller located at, for example, a control center, and more than one secondary controller separately connected to the power supply of different cars, so that more than one car may be supervised and managed with only one master controller.

With the present invention, the alarm device is no longer limited to the semi-mechanical structure, and may be set to different working ranges. The alarm device of the present invention also has wide applications to enable effective management of a large number of articles with reduce manpower and time. For example, more than one car may be supervised via only one set of the alarm device of the present invention when more than one secondary controller is provided.

And, since the alarm device of the present invention may be set to different working ranges, the master and the secondary controllers thereof would emit light and sounds at the same time as soon as the secondary controller, which is connected to an article to be supervised, is moved out of the preset working range of the master controller or is out of power supply and fails to transmit a feedback signal to the master controller.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a conventional alarm device;

FIG. 2A is a block diagram of a two-piece adjustable auto-search alarm device according to a preferred embodiment of the present invention;

FIG. 2B is a perspective view of a master controller and secondary controller for the two-piece adjustable auto-search alarm device of the present invention;

FIG. 3A is a top view of the master controller of FIG. 2B;

FIG. 3B is a front view of the master controller of FIG. 2B;

FIG. 3C is a right side view of the master controller of FIG. 2B;

FIG. 4A is a front view of a secondary controller for the two-piece adjustable auto-search alarm device of the present invention;

FIG. 4B is a perspective view of the secondary controller of FIG. 4A;

FIG. 5 is a circuit diagram for the secondary controller of the present invention;

FIG. 6 is a circuit diagram for the mater controller of the present invention;

FIG. 7 shows a mobile phone that is a first example with which the present invention may be used;

FIG. 8 shows a water-pumping system in a building that is a second example with which the present invention may be used;

FIG. 9 shows a water-pumping system in a fish farm that is a third example with which the present invention may be used;

FIG. 10A is a top view of the master controller of the present invention;

FIG. 10B is a front view of the master controller of the present invention;

FIG. 10C is a right side view of the master controller of the present invention;

FIG. 11 is a perspective view of the master controller of the present invention;

FIG. 12A is a top view of the master controller of the present invention;

FIG. 12B is a front view of the master controller of the present invention;

FIG. 12C is a right side view of the master controller of the present invention; and

FIG. 13 is a perspective view of the master controller of the present invention.

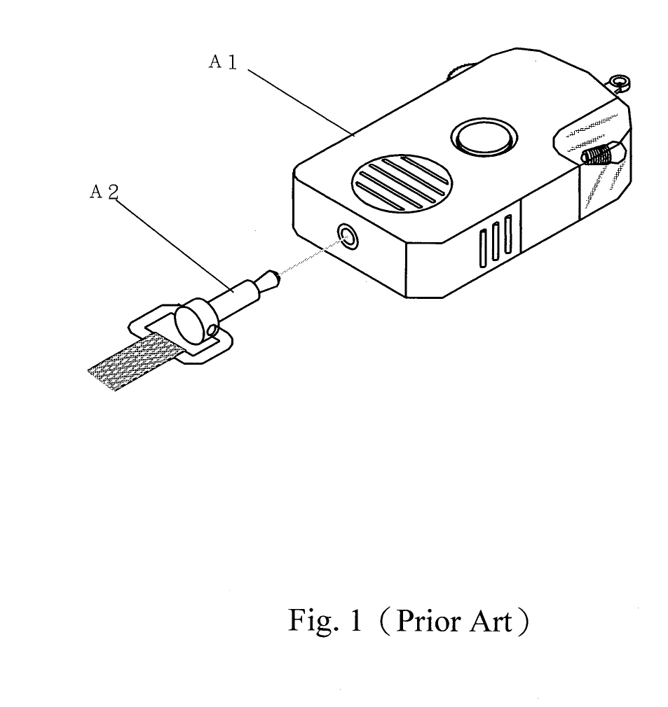

### DETAILED DESCRIPTION OF THE PREFERRED EMBODIMENTS

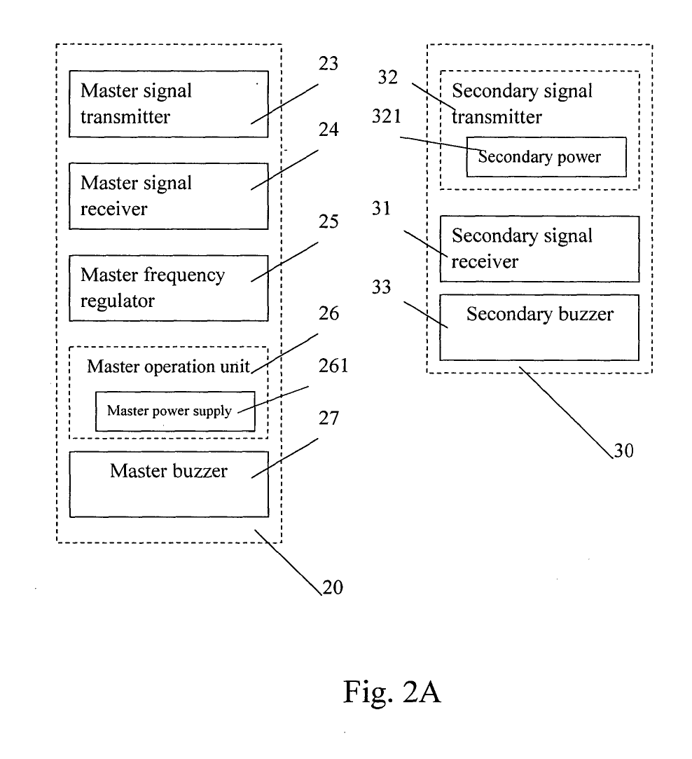

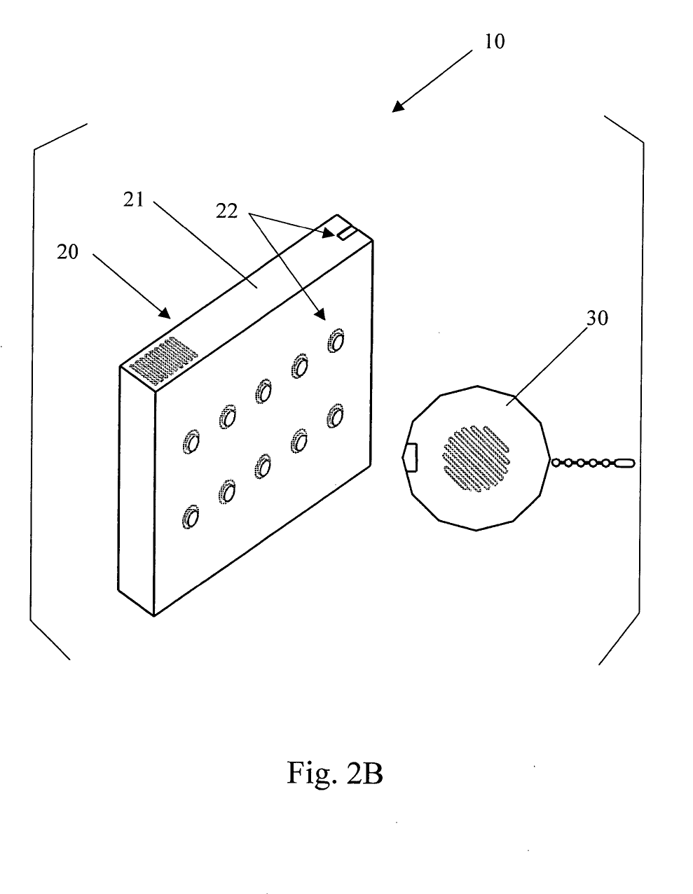

Please refer to FIG. 2A that is a block diagram of a two-piece adjustable auto-search alarm device 10 according to a preferred embodiment of the present invention. As shown, the auto-search alarm device 10 mainly includes a master controller 20 and a secondary controller 30. The master controller 20 is internally provided with a master signal transmitter 23, a master signal receiver 24, a master frequency regulator 25, a master operation unit 26, and a master buzzer 27. The secondary controller 30 is internally provided with a secondary signal receiver 31, a secondary signal transmitter 32, and a secondary buzzer 33.

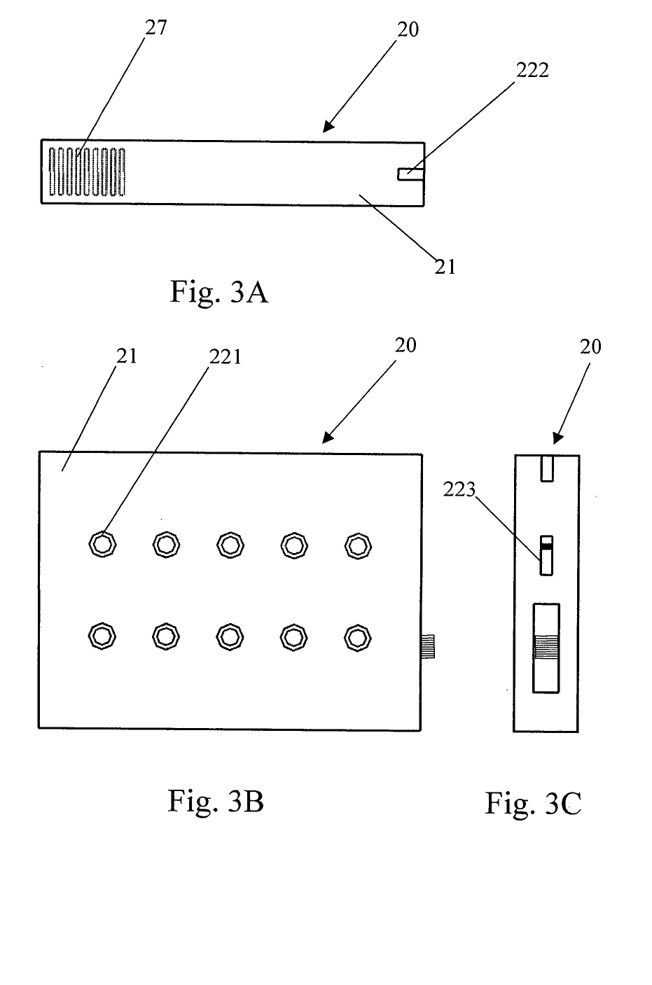

FIG. 2B is a perspective view of the master controller 20, and FIGS. 3A, 3B, and 3C are top, front, and right side views, respectively, of the master controller 20. As shown, the master controller 20 includes a housing 21, on which a plurality of light-emitting diode (LED) lamps 22 are provided. The LED lamps 22 are further divided into a plurality of tricolor LED lamps 221 provided at a front side of the housing 21, a bicolor LED lamp 222 provided at, for example, an upper right corner of the housing 21, and a power light 223 provided at, for example, a right side of the housing 21.

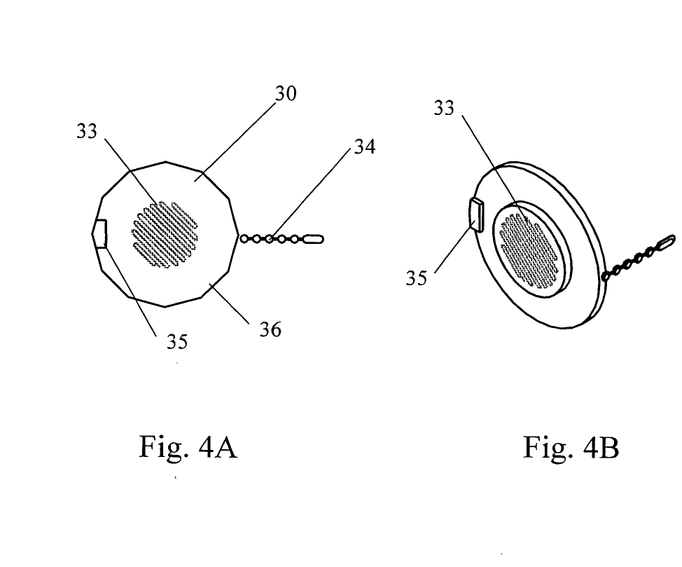

Please refer to FIGS. 4A and 4B that are top and perspective views, respectively, of the secondary controller 30. As shown, the secondary controller 30 includes a case 36, on which more than one LED lamp 35 is provided. A chain 34 is connected to the case 36 to enable convenient carrying of the secondary controller 30 with a user.

Please refer back to FIG. 2A. The internal master signal transmitter 23 is adapted to transmit a signal of a specific frequency, and the internal secondary signal receiver 31 is adapted to receive the signal transmitted from the master signal transmitter 23. The internal secondary signal transmitter 32 is adapted to transmit a signal of a specific signal, and includes a secondary power supply 321. The internal master signal receiver 24 is adapted to receive the signal transmitted from the secondary signal transmitter 32. The internal master frequency regulator 25 is adapted to regulate a transmitting frequency of the master signal transmitter 23. The internal master operation unit 26 is adapted to conduct an operation on the signal transmitted from the secondary signal transmitter 32, and includes a master power supply 261. The master buzzer 27 is adapted to emit sounds in response to a signal from the master operation unit 26. And, the secondary buzzer 33 is adapted to emit sounds in response to a signal from the master operation unit 26.

The master signal receiver 24 may advantageously receive more than one signal transmitted from more than one secondary signal transmitter 32 at the same time. For example, a kindergarten teacher may carry a master controller 20 and each of the young students of the kindergarten may carry a secondary controller 30 in an outdoor activity, such as visiting an exhibition. The master controller 20 may be regulated to have a proper transmitting frequency according to the area of the exhibition. In the event any young student moves to a place beyond the area set for the master controller 20, the master signal receiver 24 does not receive the signal transmitted from the secondary controller 30 carried by that young student and would cause the master and the secondary controller 20, 30 to emit sounds at the same time. Therefore, the teacher could find out which young student has lost his way and try to find the lost student as soon as possible.

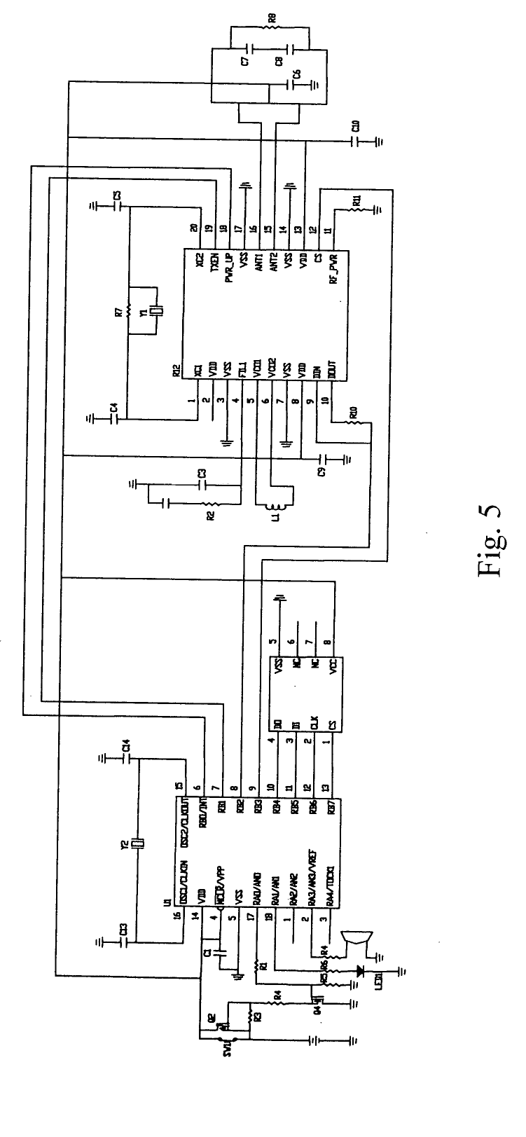

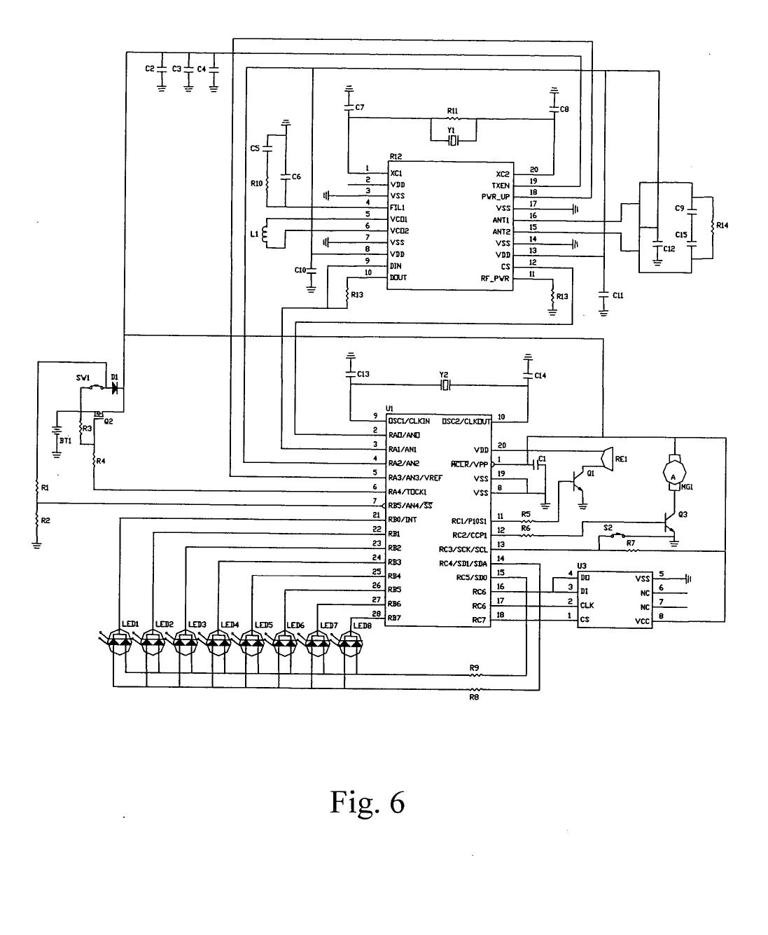

FIGS. 5 and 6 are circuit diagrams of the secondary and the master controller 20, 30, respectively. However, it is understood these circuit diagrams are only two exemplified circuitries for the present invention, and may be substituted with other suitable circuitries.

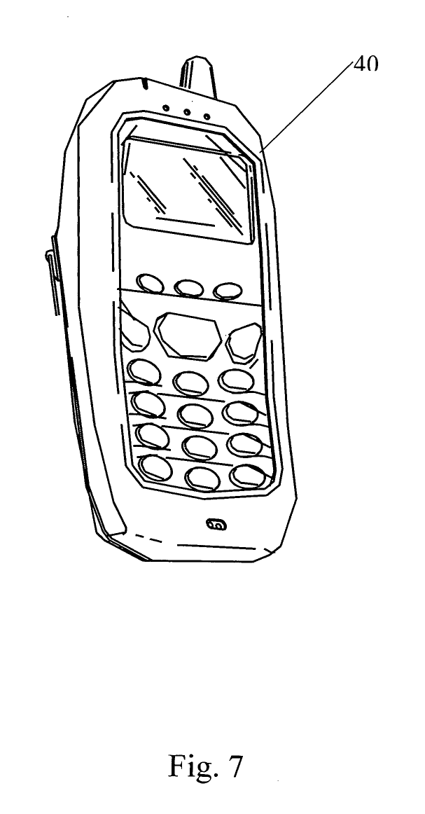

In a first example of using the present invention, the master controller 20 is carried by a user and the secondary controller 30 may be connected to a mobile phone 40 or associated with a battery of the mobile phone 40, and gets power from the mobile phone 40, as shown in FIG. 7. Similarly, the secondary controller 30 may be otherwise connected to a personal digital assistant (not shown).

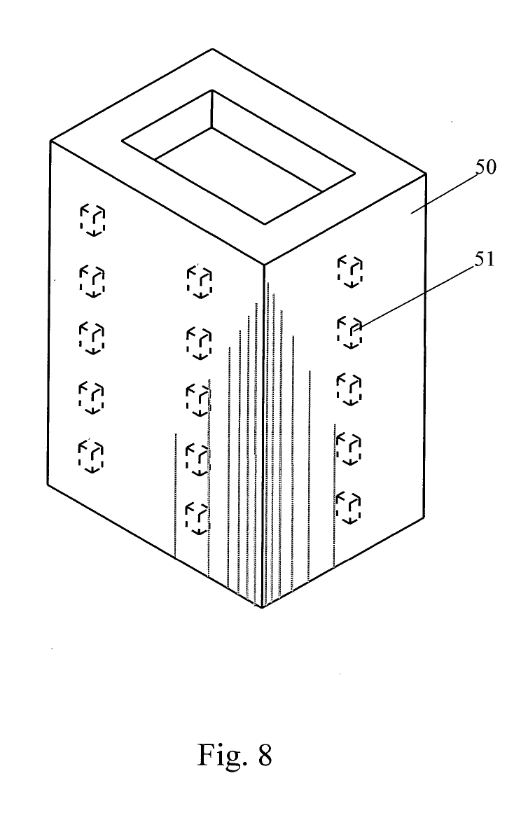

As a second example, the present invention may be used to manage a water-pumping system in a building 50, as shown in FIG. 8. In this case, the master controller 20 is located at a control center of the building 50, and a plurality of secondary controllers 30 may be separately connected to individual pump motors 51 in the building 50 and get power from the pump motors 51. In the event any of the pump motors 51 is failed and could not supply power to the secondary controller 30 connected thereto, no signal could be fed back from that secondary controller 30 to the master controller 20. Therefore, a manager of the building 50 may easily locate which pump motor 51 has trouble without the need to check the pump motors 51 one by one.

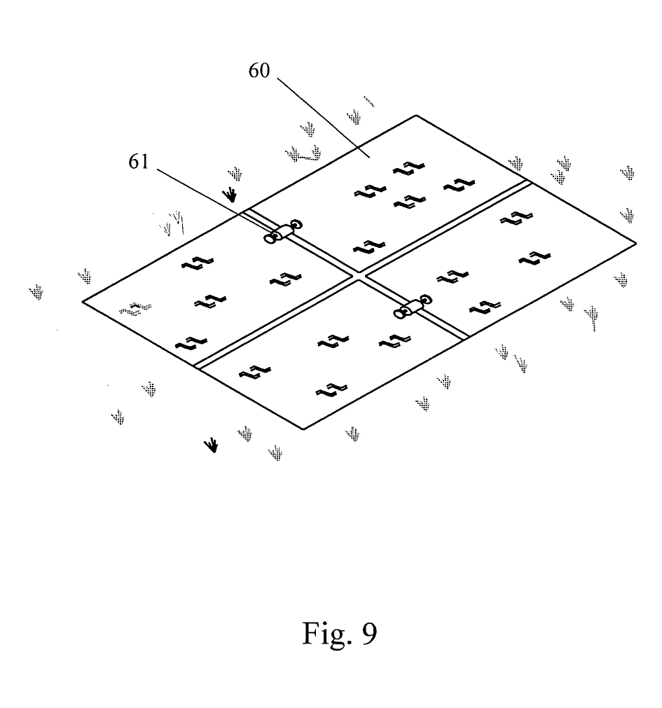

As a third example, the present invention may be used to maintain motors 61 included in a fish farm 60, as shown in FIG. 9. In this case, the master controller 20 is located at a predetermined position accessible by an operator, and a plurality of secondary controllers 3 may be separately connected to the motors 61 and get power from the motors 61. In the event any of the motors 61 is failed and could not supply power to the secondary controller 30 connected thereto, no signal could be fed back from that secondary controller 30 to the master controller 20. Therefore, the operator of the fish farm 60 may easily locate which motor 61 has trouble without the need to check the motors 61 one by one.

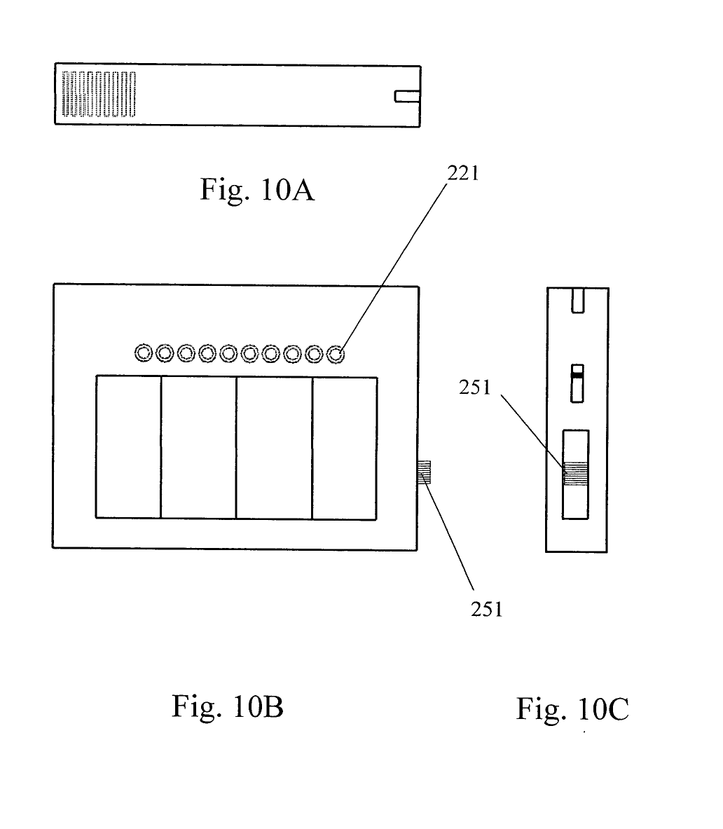

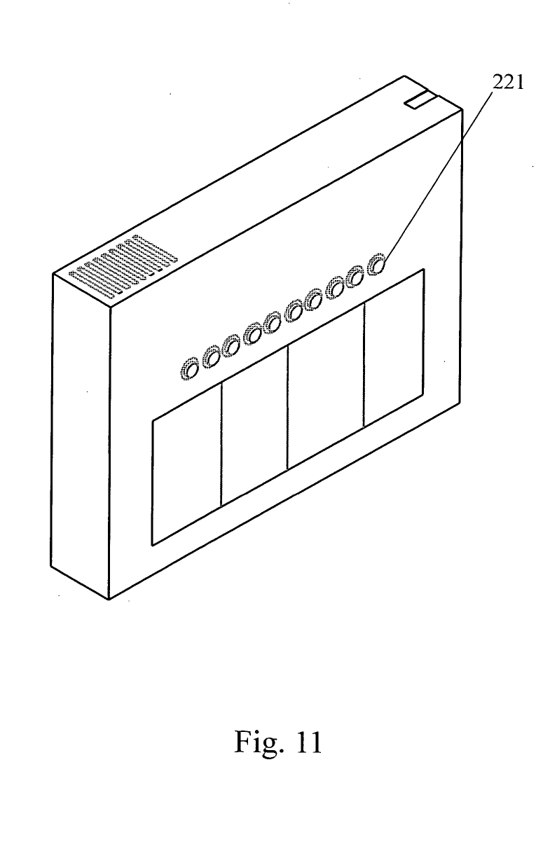

Please refer to FIGS. 10A to 10C and to FIG. 11. The master frequency regulator 25 internally provided in the housing 21 of the master controller 20 includes a frequency-regulating knob 251 exposed from one side of the housing 21. With the frequency-regulating knob 251, three different signal-transmitting ranges may be set for using in different conditions to achieve different effects. For example, the first range is from 3 to 5 meters and is suitable for detecting a personal article frequently carried along with the user, the second range from 30 to 50 meters suitable for using in outdoor activities, such as visiting an exhibition as mentioned above, and the third range from 300 to 500 meters suitable for monitoring and managing, for example, cars on a parking lot.

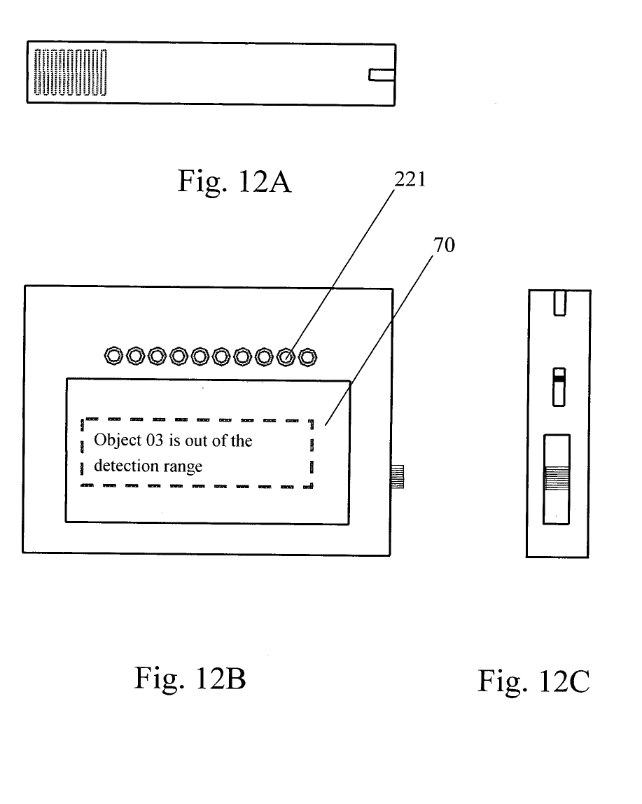

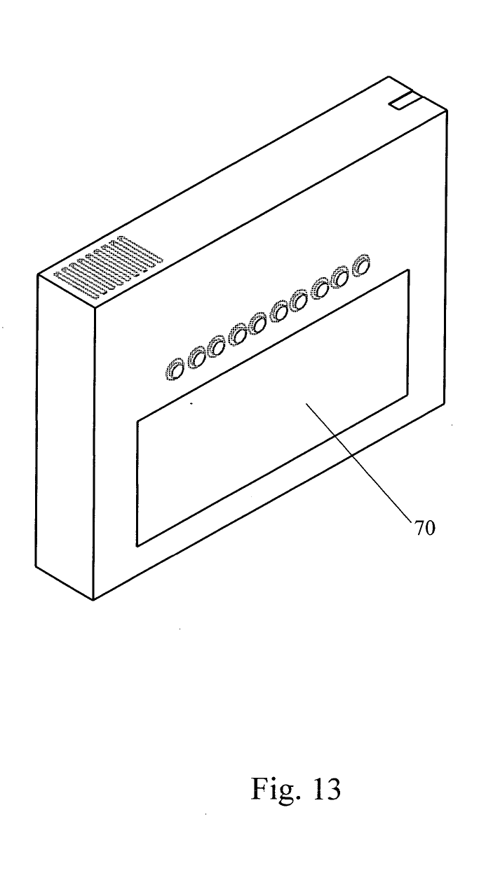

Please refer to FIGS. 12A to 12C and to FIG. 13 that shows another embodiment of the present invention, of which the master controller 20 may further includes a liquid crystal display (LCD) screen 70. When the number of the secondary controllers 30 working with the master controller 20 exceeds the number of the tricolor LED lamps 221 provided on the master controller 20, information about which secondary controller 30 is located beyond the preset range may be displayed on the LCD screen 70, as shown in FIG. 12B.

In brief, in the two-piece adjustable auto-search alarm device 10 of the present invention, the master controller 20 and the secondary controllers 30 are in a one-to-many relation, and a two-way alarm function is provided for supervising and managing purpose, enabling the present invention to be used in many different applications. Moreover, the present invention has simple structure to enable mass production thereof at largely increased efficiency and reduced manufacturing cost to meet the consumers' requirement, and is therefore industrially valuable for production and highly practical for use.

The present invention has been described with some preferred embodiments thereof and it is understood that many changes and modifications in the described embodiments can be carried out without departing from the scope and the spirit of the invention that is intended to be limited only by the appended claims.

1. A two-piece adjustable auto-search alarm device, comprising:
a master controller having a housing and more than one LED lamp provided on said housing;
a secondary controller having a case and more than one LED lamp provided on said case;
a master signal transmitter provided in said master controller for transmitting a signal of a specific frequency;
a secondary signal receiver provided in said secondary controller for receiving said signal transmitted from said master signal transmitter;
a secondary signal transmitter provided in said secondary controller for transmitting a signal of a specific frequency, and including a secondary power supply;
a master signal receiver provided in said master controller for receiving said signal transmitted from said secondary signal transmitter;
a master frequency regulator provided in said master controller for regulating a signal transmitting frequency of said master signal transmitter; and
a master operation unit provided in said master controller for conducting an operation on said signal transmitted from said secondary signal transmitter, and including a master power supply;
said master frequency regulator being adjustable to enable different signal transmitting ranges, and said master controller being unable to receive a signal from said secondary signal transmitter that is either located beyond said signal transmitting range set with said master frequency regulator or fails to feed back a signal to said master controller due to, for example, losing a power supply; and said LED lamps provided on said master and said secondary controller becoming on at the same time as soon as said master signal receiver does not receive a signal transmitted from said secondary signal transmitter.

2. The two-piece adjustable auto-search alarm device as claimed in claim 1, wherein said master controller further includes a master buzzer.

3. The two-piece adjustable auto-search alarm device as claimed in claim 2, wherein said master buzzer emits sounds in response to a signal sent from said master operation unit.

4. The two-piece adjustable auto-search alarm device as claimed in claim 1, wherein said secondary controller further includes a secondary buzzer.

5. The two-piece adjustable auto-search alarm device as claimed in claim 4, wherein said secondary buzzer emits sounds when said secondary controller does not have power supplied thereto.

6. The two-piece adjustable auto-search alarm device as claimed in claim 1, wherein said LED lamps provided on said master controller include more than one tricolor LED lamp, a bicolor LED lamp, and a power light.

7. The two-piece adjustable auto-search alarm device as claimed in claim 1, wherein said master signal receiver is adapted to receive signals separately transmitted from one or more secondary signal transmitters.

8. The two-piece adjustable auto-search alarm device as claimed in claim 1, wherein said secondary controller may be connected to a battery of a mobile phone.

9. The two-piece adjustable auto-search alarm device as claimed in claim 1, wherein said secondary controller may be connected to a battery of a personal digital assistant.

10. The two-piece adjustable auto-search alarm device as claimed in claim 1, wherein said secondary controller may be connected to an individual pump motor included in a water-pumping system for a build.

11. The two-piece adjustable auto-search alarm device as claimed in claim 1, wherein said secondary controller may be connected to an individual motor included in a water-pumping system for a fish farm.

12. The two-piece adjustable auto-search alarm device as claimed in claim 1, wherein said master frequency regulator includes a frequency-regulating knob provided on said housing of said master controller.

13. The two-piece adjustable auto-search alarm device as claimed in claim 1, wherein said master controller is provided on said housing with an LCD screen.
